(19) United States
(12) Patent Application Publication
(10) Pub. No.: US 2011/0293682 A1
(43) Pub. Date: Dec. 1, 2011

(54) SELF-TRIGGERED MICROENCAPSULATED BIOCIDES AND/OR FUNGICIDES

(75) Inventors: Michael J. Walker, Windsor (CA); Charles H. Olk, Leonard, MI (US)

(73) Assignee: GM GLOBAL TECHNOLOGY OPERATIONS, INC., Detroit, MI (US)

(21) Appl. No.: 12/786,884

(22) Filed: May 25, 2010

(51) Int. Cl. A01N 25/34; A01P 1/00; A01N 31/14

(52) U.S. Cl. 424/408; 514/721

(57) ABSTRACT

One embodiment includes a biocide-containing and/or fungicide-containing microcapsule wherein the microcapsule may be capable of degradation due to the presence of byproducts that are released by a fungi or biological organism. Upon release, the biocide and/or fungicide may then be utilized to eliminate the fungi or biological organism.

### TECHNICAL FIELD

The field to which the disclosure generally relates to microcapsules containing a biocide and/or fungicides. More particularly, the disclosure relates to a biocide-containing and/or fungicide containing microcapsule that is capable of degrading due to the presence of a fungi or biological organism.

### BACKGROUND

Microbial cells (i.e. microorganisms) such as bacteria and fungi create enzymes or other volatile organic compounds (VOCs) as metabolic byproducts (collectively, MVOCs) that can dissolve complex polymers such as cellulose, lignin and chitin and are known to cause discoloration, odor, and deterioration of mechanical properties of these and other polymeric materials.

These MVOCs may be detectable before any visible signs of microbial growth appear. Complex mixtures of MVOCs that may be generated by microorganisms include alcohol, ketones, aldehydes, aromatic and chlorinated hydrocarbons, and terpenes as well as other enzymes.

Biocides and fungicides have long been used to protect materials from attack by microbial cells. The life of any product where biocide and/or fungicides are applied will be more if the biocides and/or fungicides are retained for longer periods of time. Reduction in biocidal or fungicidal activity is mostly attributed to the factors such as chemical degradation of the biocide and/or fungicide. Reduction in activity may also occur due to fast dissipation of the biocide and/or fungicide from the application site due to its volatility or washing out.

### SUMMARY OF EXEMPLARY EMBODIMENTS OF THE INVENTION

One embodiment includes a biocide-containing and/or fungicide-containing microcapsule wherein the microcapsule may be capable of degradation due to the presence of byproducts that are released by a fungi or biological organism. Upon release, the biocide and/or fungicide may then be utilized to eliminate the fungi or biological organism.

In a related exemplary embodiment, these microcapsules may be introduced to products desiring sustained elimination of fungi or biological organisms.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is a schematic illustration of a microcapsule according to an exemplary embodiment;

FIG. 2 is a schematic representation of a product according to an exemplary embodiment including the microcapsule of FIG. 1; and

FIG. 3 is a schematic representation of a product according to another exemplary embodiment including the microcapsule of FIG. 1.

### DETAILED DESCRIPTION OF EXEMPLARY EMBODIMENTS

The following description of the embodiment(s) is merely exemplary (illustrative) in nature and is in no way intended to limit the invention, its application, or uses.

Extended duration of biocidal and/or fungicidal activity in a product may be enhanced by incorporating a biocide and/or a fungicide in an extended or controlled release form. Microencapsulation may be used to control the release of biocides and/or fungicides, wherein an active agent (core material of the biocide and/or fungicide) is surrounded by a polymer film or is substantially uniformly dispersed in a polymer matrix.

Biocides and fungicides can also be toxic or discomforting to humans or animals or on a long term basis detrimental to the product that they are meant to protect. Over the long term, by encapsulating the biocide and/or fungicide the exposure of the biocide to humans, animals or product is reduced thus reducing the toxicity or material degradation of the biocide/fungicide. Alternatively, when encapsulated, more effective biocides/fungicides may also now be introduced that would have been excluded because of their chronic exposure limits.

The exemplary embodiments relate to biocide and/or fungicide containing microcapsules which degrade in the presence of sufficiently high levels of microbial-generated volatile organic compounds (MVOCs) from microorganisms, therein releasing the biocide and/or fungicide to attack the microorganism. These microcapsules may then be included within a wide variety of potential products and therein may aid in protecting the products from degradation associated with microbial growth. The eradication of microorganisms may also provide a measure of environmental protection to animals and the environment associated with microbial growth. The encapsulation of the biocide/fungicide may also provide a measure of environmental protection to the products, animals and the environment associated with the biocide/fungicide.

A “sufficiently high level” means the minimum level of MVOC necessary to cause the degradation of the microcapsule. Such “sufficiently high level” may be different depending upon numerous factors, including but not limited to the composition, thickness and microstructure of the microcapsule and also due to the composition of the MVOC attacking the microcapsule, temperature, and humidity.

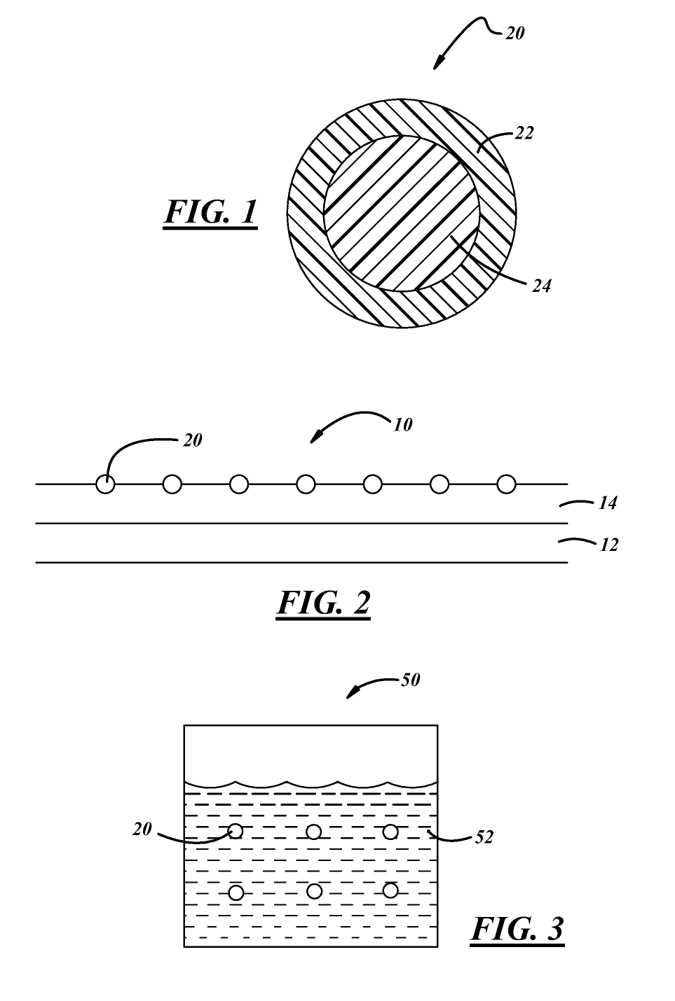

Referring first to FIG. 1, a microcapsule 20 according to one exemplary embodiment may be shown as having an outer shell 22 encasing an encapsulated material 24.

The outer shell 22 of the microcapsule 20 may be formed from a material that readily decomposes in the presence of sufficient levels of MVOCs, but is otherwise substantially non-degradable with respect to any component of a product (such as product 10 in FIG. 2 below or product 50 in FIG. 3 below) to which it is introduced and is substantially non-degradable with respect to the encapsulated material 24. The outer shell 22 may also be non-degradable with respect to the environment factors to which it is introduced, wherein the environment factors include such factors as temperature, light, moisture and the like.

The level of MVOC necessary to decompose the outer shell 22 may be determined by the application's tolerance to bio-contamination and its intended environment. The choice of composition of the outer shell 22, the microstructure of the outer shell 22, and the associated thickness of the outer shell 22 may each be independently and collectively determined as a function of the application's tolerance to bio-contamination and its intended environment.

Non-limiting examples of polymeric materials that may be utilized in the outer shell 22 include biodegradable polymers such as cellulose, chitin, and lignin, which may dissolve in the presence of cellulose, phenol oxidase, and ligninase respectively, substances which are known to be the metabolic byproducts evidencing the presence of one or more microorganisms.

The encapsulated material 24 may include a biocide or a fungicide, or may include both a biocide and fungicide. Non-limiting examples of biocides and fungicides that may encapsulated within the outer shell 22 include oxybisphenoxarsine (made by Akzo Nobel of Brazil), triclosan (trichlorophenoxy phenyl) (a non-metal containing organic biocide made by Ciba Specialty Chemicals, two specific triclosan-based antimicrobials being SB-30 and 7040 available from Morton International), Intercide ZnP (a biocide based on zinc pyrithione made by Olin Corp.), Preventol A8 (an organic azole-based fungicide and mildewcide utilizing Tebuconazole as an active ingredient and available from Bayer Corp.), Metasol TK-100 (a thiabendizole-based mildewcide and fungicide available from Calgon Corp.), two MicroFree inorganic antimicrobials available from DuPont Specialty Chemicals (one grade is 98% zinc oxide with a small amount of silver and other inorganics; the other is 98% tin dioxide with small amounts of silver zinc and copper), Vinyzene IT-4000 and IT-4010 (isothiazolone-based biocides available from Morton International), Omacide (a biocide based on zinc pyrithione available from Olin Corp.), and Troysan Polyphase (a carbamate-based organic biocide available from Troy Corp.).

One exemplary embodiment of a product 10 is illustrated in FIG. 2 as having a substrate 12 coated with a coating 14 that includes one or more microcapsules 20.

The substrate 12 can take on many forms and is not limited to material choice, thickness, or any other factor, but is instead dependent upon the product 10 in which it is utilized.

One class of products 10 in accordance with FIG. 2 in which the microcapsules 20 may be utilized may be products in which the presence of microorganisms on the substrate 12 or in the coating 14 may be harmful or otherwise detrimental to the environment and/or to animal health. For example, if the product 10 is an air conditioning system or a humidifier system, and the substrate 12 is a filter, the presence of a microorganism on the filter substrate 12 (or on the coating 14 coupled to the substrate 12) may lead to human exposure which ultimately may be harmful to a human. Similarly, if the product 10 is a car seat, and the substrate 12 is upholstery, the presence of a microorganism on the substrate 12, or on the coating 14, may lead to human exposure which ultimately may be harmful to a human.

In one exemplary embodiment, the encapsulated material 24 may be effective to substantially remove or otherwise eliminate or eradicate the microorganisms from the substrate 12 and/or the coating 14 in close proximity to the microcapsule 20 with adversely affecting the substrate 12 and/or the coating 14 as the microcapsule 20 degrades and the encapsulated material 24 is released

Another class of products 10 in accordance with FIG. 1 in which the microcapsules 20 may be utilized are products 10 in which the presence of microorganisms on the substrate 12 may be harmful or otherwise detrimental to the substrate 12 or to the coating 14 itself. For example, wherein the substrate 12 or coating 14 are degradable due to the presence of the microorganism itself, or due to the MVOCs produced by the microorganism present, it is highly desirable to remove the microorganisms from the substrates 12 and/or the coatings 14 quickly before the substrate 12 and/or coating 14 can be substantially degraded. For example, the afore-mentioned filter for the air conditioning system or humidifier system, or the upholstery for a car seat, may be formed from a material that is degradable due to the presence of a microorganism, wherein the coating 14 including the microcapsule 20 is designed to prevent degradation of the substrate 12 from both environmental concerns normal to its use and further due to microorganism growth.

In another example, the coating itself 14 may be a paint in which the MVOCs may degrade one or more components of its composition, leading to degradation of the paint film and possible exposure of the underlying substrate 12, which may in turn adversely affect the performance of the product 10 to which the coating 14 is applied.

In another exemplary embodiment, as shown in FIG. 3, a product 50 is illustrated as having a microcapsule 20 as described in FIGS. 1 and 2 above that is mixed or otherwise dispersed within a liquid material 52, wherein the liquid material may degrade due to the presence of MVOCs.

Exemplary products 50 that may be included as shown in FIG. 3 are industrial solvents or paints that include one or more components that are degradable in the presence of MVOCs. The presence of the degradable microcapsule 20 therefore may extend the life of the product 50.

The method for protecting the products or the environment surrounding the products is substantially the same whether the products are formed in accordance with the exemplary embodiment of FIG. 2 or of FIG. 3.

Thus, the exemplary embodiments provide a method wherein the presence of microorganisms can “self-trigger” the timed release of biocides and/or fungicides from microcapsules that eliminate or eradicate the microorganisms. This timed release may extend the life of products utilizing the microcapsules, and may also limit exposure to microorganisms to the environment.

While the exemplary embodiments discuss a limited number of products in which use if contemplated, such a list should not be deemed exhausting. Many other types of products may utilize the self-triggering microcapsules of the exemplary embodiments and still fall within the spirit of the present invention. For example, the self-triggering microcapsule may find use in a wide variety of applications that may require a level of protection against microorganism exposure.

The above description of embodiments of the invention is merely exemplary in nature and, thus, variations thereof are not to be regarded as a departure from the spirit and scope of the invention.

What is claimed is:

1. A product comprising:
an encapsulated material comprising at least one of a biocide or a fungicide; and
a microcapsule encapsulating said encapsulated material, said microcapsule comprising a biodegradable composition that breaks down to release said encapsulated material at a sufficient level of microbially-generated volatile organic compounds.

2. The product of claim 1, wherein said biodegradable composition comprises cellulose.

3. The product of claim 1, wherein said biodegradable composition comprises chitin.

4. The product of claim 1, wherein said biodegradable composition comprises lignin.

5. The product of claim 1, wherein said biodegradable composition forms a outer shell having a predetermined wall thickness, wherein said predetermined wall thickness for said outer shell is sufficiently thick to prevent degradation of said outer shell in the absence of said sufficient level of microbially-generated volatile organic compounds but is sufficiently thin to release said microencapsulated biocide and/or fungicide in the presence of said sufficient level of microbially-generated volatile organic compounds.

6. The product of claim 1, wherein said biodegradable composition forms a outer shell having a predetermined wall thickness with a predefined microstructure, wherein said predetermined wall thickness with said predefined microstructure for said outer shell is sufficient to prevent degradation of said outer shell in the absence of said sufficient level of microbially-generated volatile organic compounds but allows the release of said microencapsulated biocide and/or fungicide in the presence of said sufficient level of microbially-generated volatile organic compounds

7. A product comprising:
(a) a substrate;
(b) a coating coupled to said substrate, said coating including a microencapsulated biocide and/or fungicide, said microencapsulated biocide and/or fungicide comprising:
an encapsulated material comprising at least one of a biocide or a fungicide; and
a microcapsule encapsulating said encapsulated material, said microcapsule comprising a biodegradable outer shell that breaks down to release said encapsulated material at sufficiently high levels of microbially-generated volatile organic compounds.

8. The product of claim 7, wherein said biodegradable outer shell comprises cellulose, chitin, or lignin.

9. The product of claim 7, wherein said biodegradable outer shell has a predetermined wall thickness that is sufficiently thick to prevent degradation of said outer shell in the absence of said sufficient level of microbially-generated volatile organic compounds but is sufficiently thin to release said microencapsulated biocide and/or fungicide in the presence of said sufficient level of microbially-generated volatile organic compounds.

10. The product of claim 7, wherein said biodegradable outer shell has a predetermined wall thickness with a predefined microstructure, wherein said predetermined wall thickness with said predefined microstructure is sufficient to prevent degradation of said biodegradable outer shell in the absence of said sufficient level of microbially-generated volatile organic compounds but allows the release of said microencapsulated biocide and/or fungicide in the presence of said sufficient level of microbially-generated volatile organic compounds

11. A method for reducing microorganism levels on a product having a substrate comprising:
forming a microencapsulated biocide and/or fungicide comprising an encapsulated material comprising at least one of a biocide or a fungicide and a microcapsule having an outer shell encapsulating said encapsulated material;
coupling said microencapsulated biocide and/or fungicide onto the substrate; and
releasing said microencapsulated biocide and/or fungicide from said microcapsule when a sufficient level of microbially-generated volatile organic compounds are present in close proximity to said microcapsule to remove the microorganisms from the substrate, wherein the presence of said sufficient level of said microbially-generated volatile organic compounds causes said microcapsule to degrade to release said microencapsulated biocide and/or fungicide.

12. The method of claim 11, wherein said microcapsule comprises a cellulose microcapsule.

13. The method of claim 11, wherein said microcapsule comprises a lignin microcapsule.

14. The method of claim 11, wherein said microcapsule comprises a chitin microcapsule.

15. The method of claim 11 further comprising:
determining one or more microorganisms that may degrade the product;
determining one or more compositions of said microcapsule that will degrade in the presence of a sufficient level of microbially-generated volatile organic compounds generated from said one or more microorganisms; and
forming a microcapsule from one of said one or more compositions.

16. The method of claim 15 further comprising:
determining a wall thickness for said outer shell that is sufficiently thick to prevent degradation of said microcapsule in the absence of a sufficient level of microbially-generated volatile organic compounds from said one or more microorganisms but sufficiently thin to release said microencapsulated biocide and/or fungicide in the presence of said sufficient level of microbially-generated volatile organic compounds; and
forming said microcapsule having an outer shell at said determined wall thickness.

17. The method of claim 15 further comprising:
determining a wall thickness with an associated microstructure for said outer shell that prevents degradation of said microcapsule in the absence of a sufficient level of microbially-generated volatile organic compounds from said one or more microorganisms but allows release of said microencapsulated biocide and/or fungicide in the presence of said sufficient level of microbially-generated volatile organic compounds; and
forming said microcapsule having an outer shell at said determined wall thickness with said associated microstructure.

18. The method of claim 15 further comprising:
determining a composition of one or more biocides that may eliminate said one or more microorganisms upon contact;
determining whether said one or more biocides will degrade said microcapsule; and
selecting said composition of said one or more biocides that will eliminate said one or more microorganisms on contact but will not degrade said microcapsule.

19. The method of claim 15 further comprising:
determining a composition of one or more fungicides that may eliminate said one or more microorganisms upon contact;
determining whether said one or more fungicides will degrade said microcapsule; and
selecting said composition of said one or more fungicides that will eliminate said one or more microorganisms on contact but will not degrade said microcapsule.

20. The method of claim 15 further comprising:
determining a composition of one or more fungicides and one or more biocides that may eliminate said one or more microorganisms upon contact;
determining whether said one or more fungicides and said one or more biocides will degrade said microcapsule; and
selecting said composition of said one or more fungicides and said one or more biocides that will eliminate said one or more microorganisms on contact but will not degrade said microcapsule.
